(19) United States
(12) Patent Application Publication
(10) Pub. No.: US 2007/0150907 A1
(43) Pub. Date: Jun. 28, 2007

(54) Scheduling method for remote object procedure call and system thereof

(75) Inventors: Jenq Kuen Lee, Tainan City (TW); Chung Kai Chen, Gangshan Township (TW); Yu Hao Chang, Tainan City (TW)

Correspondence Address: John S. Egbert;Egbert Law Offices, 7th Floor, 412 Main Street, Houston, TX, 77002, US

(73) Assignee: NATIONAL TSING HUA UNIVERSITY, Hsinchu (TW)

(21) Appl. No.: 11/406,864

(22) Filed: Apr. 19, 2006

(30) Foreign Application Priority Data
Dec. 13, 2005 (TW) 094144000

(51) Int. Cl. G06F 9/46

(52) U.S. Cl. 719/330

(57) ABSTRACT

The present invention discloses a scheduling method for remote object procedure call and system thereof, by a two-phase scheduling mechanism to deal with the stateful and stateless invocations simultaneously. First, plural stateful invocations in a workflow are grouped into plural groups of stateful tasks. Then, the groups of stateful tasks are assigned to the server with the minimum load. Next, the rank of each of the stateful and stateless invocations is determined to form a scheduling sequence. An estimated finish time for each stateless invocation for each server is calculated and the stateless invocation is assigned to the server with the minimum estimated finish time.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The present invention relates to a scheduling method for remote object procedure call and a system thereof, and more particularly to a scheduling method for remote object procedure call and a system thereof based on the management of stateful invocations and stateless invocations, which is especially suitable for the remote object procedure call complying with TCP (Transmission Control Protocol) channel.

### BACKGROUND OF THE INVENTION

Distributed object-oriented environments have become important platforms for parallel and distributed service frameworks. According to the connection of high-speed networks, components that are located in different networks can share resources and serve each other. The improvement of performance and utility of the distributed object-oriented computing environment has become an important issue.

The grid environment has been developed for a long time, and related researchers have been focusing on a global distributed object-oriented service environment. During the development of the global distributed object-oriented service environment, the establishment of standards and protocols is a most time-consuming process, which is gradually completed. When the platforms are formed and becoming practical, the combination of various applications in the future and the advanced network technologies is a critical point for integration of diverse important technologies.

As for the development of the distributed object-oriented service in the grid environment, how to optimize the distributed components is an important category. First, one must set up the cooperation among different distributed components, such as the objects of Java Remote Method Invocation (Java RMI), .NET Remoting, Common Component Architecture (CCA) and Open Grid Services Architecture (OGSA). All the above languages exhibit the function of remote calling. If the cooperation among the components in different platforms is established, the reuse and applications of the components will be improved. Therefore, how to overcome the barriers among the different languages is an important topic. Also, how to replace the components dynamically according to different environments to improve the performance and to meet the security requirement becomes a mainstream of research, for example, Component Management Services (CMS). Facing the aforesaid distributed components' environment, the traditional distributed load-balancing mechanism, in which different protocols and platforms are involved and difficulty in the process is increased, cannot meet the requirements (i.e., security, performance, and so on). Currently, there is an issue of stateful invocations that needs solving in remote procedure call service, which is described below. A stateful invocation means it has to save the state thereof in the server for the next call (i.e., the next stateful invocation). That is, there is dependence between the stateful invocation and the next stateful invocation. Thus, a server is required to keep the state of the stateful invocation in the distributed component environment. However, traditional scheduling methods cannot deal with the issue or cannot optimize the result of scheduling based on the characteristics of the components. In contrast to the stateful invocations that have to be assigned to the servers in advance, the stateless invocations are not assigned to the servers in advance.

As for the scheduling in the distributed component environment, so far, many scheduling methods are proposed using the information of the workflows, but they still cannot solve the aforesaid issue effectively. For the traditional scheduling methods, they need a mechanism capable of supporting the stateful invocations and the stateless invocations simultaneously in order to be applied efficiently to the procedures written by the object-oriented languages with the function of remote procedure calls, such as .NET Remoting and Java RMI.

### BRIEF SUMMARY OF THE INVENTION

The objective of the present invention is to provide a scheduling method for remote object procedure call and system thereof, by a two-phase scheduling mechanism and referring to a workflow of an application program, to deal with the stateful invocations and the stateless invocations simultaneously and to achieve the optimization of scheduling invocations.

In order to achieve the objective, the present invention discloses a scheduling method for remote object procedure call, which comprises the steps of prescheduling and dynamic scheduling. The step of prescheduling, the first phase, comprises: (A1) grouping plural stateful invocations in a workflow into plural groups of stateful tasks; (A2) assigning the groups of stateful tasks to the server according to the loads of the servers; (A3) repeats Steps (A1) and (A2) until all the groups of stateful tasks are assigned; and (A4) determines the rank of each invocation (including stateful and stateless invocations), where the rank is an approximation of the length of the longest path from the invocation to the exit invocation in the workflow. The larger the rank is (i.e., the longer the length is), the earlier the associated invocation is treated.

The step of dynamic scheduling, the second phase, is performed according to the rank of each invocation. If there is a stateful invocation that is estimated to be time-out but is actually not time-out, the stateful invocation will be scheduled for the server to which the associated group of stateful tasks has been assigned. Then, the step of prescheduling will be executed for the remaining stateful invocations in the associated group of stateful tasks. If a stateful invocation is actually time-out, the stateful invocation will be scheduled for the server depending on the result of the prescheduling step. For each stateless invocation, an estimated finish time for each server is calculated, and each stateless invocation is assigned to the corresponding server with the minimum estimated finish time.

The present invention also discloses a scheduling system for remote object procedure call, comprising plural clients, plural servers, and a middle gateway. The servers respond to plural invocations from the clients. The middle gateway connects the servers and the clients to dispatch the invocations to the servers according to a load-balancing mechanism that comprises the two-phase scheduling mechanism.

The scheduling method of the present invention arranges a scheduling object (i.e., a middle gateway) between the servers and the clients. When the clients request a service from the servers (i.e., an invocation is sent from the clients to the servers), the invocation will be dispatched to the proper server according to the two-phase scheduling mechanism in the scheduling object, during which the stateful invocations and the executing status of the scheduling system are factors affecting the performance of the scheduling system and the two-phase scheduling mechanism is used to meet the requirement of load balancing. The scheduling method of the present invention is applicable to a distributed component environment.

The scheduling method and scheduling system present the following features. First, the scheduling of invocations can be performed by a third party only with the operating parameters provided by the clients and the servers. Thus, the middle gateway, which is used to perform the scheduling method of the present invention, can be disposed in the servers or at other nodes. Second, the load of the current server is considered to optimize the scheduling of the invocations, which depends on different properties of the invocations, and thus, different references. For example, if a program needs more computation capability, the computation cost will be considered; if the program needs more network communication, the bandwidth will be considered. As a result, the performance of the scheduling method of the present invention becomes more noticeable. Third, the scheduling method and the scheduling system of the present invention are applicable to any remote invocation method that utilizes Transmission Control Channel, for example, .NET Remoting or Java RMI.

### BRIEF DESCRIPTION OF THE SEVERAL VIEWS OF THE DRAWINGS

FIG. 1 shows a schematic view of the scheduling system of the present invention.

FIG. 2 is a schematic view of the flow chart of the scheduling method of the present invention.

FIG. 3(a) shows a schematic view of a workflow of a simple application.

FIG. 3(b) shows a schematic view of a matrix storing the computation cost for each task in the workflow of FIG. 3(a).

FIG. 4 shows a schematic view of the detailed steps of step S20 of FIG. 2.

FIG. 5 is a schematic view of a flow chart of performing the dynamic scheduling.

FIG. 6 is a schematic view of the simulation result of the scheduling method of the present invention.

FIGS. 7 and 8 show two graphs regarding the comparison between the performances of the scheduling method of the present invention and a traditional round-robin method.

### DETAILED DESCRIPTION OF THE INVENTION

To easily understand the scheduling method for remote object procedure call of the present invention, the scheduling system for remote object procedure call of the present invention is described first as follows.

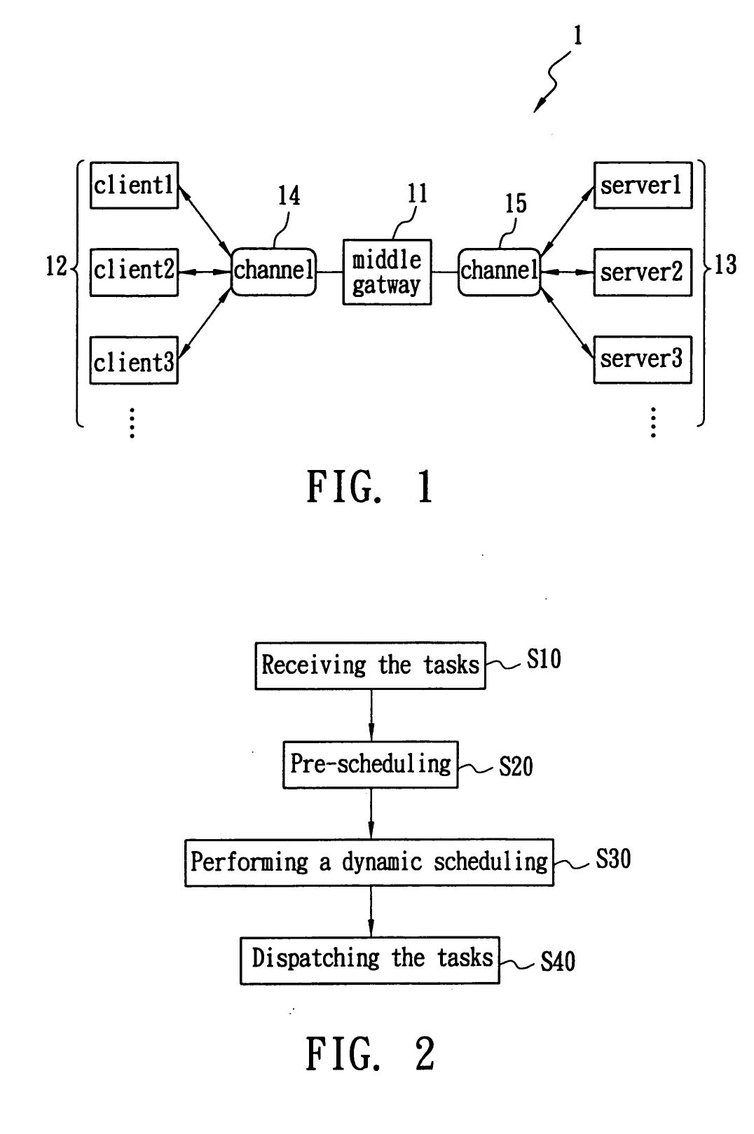

FIG. 1 illustrates the scheduling system 1 of the present invention, which comprises plural clients 12, plural servers 13, channels 14 and 15 and a middle gateway 11. The servers 13 are used to respond to plural invocations from the clients 12. The middle gateway 13 connects the clients 12 and the servers 13 and dispatches the invocations to the servers 13 according to a load-balancing mechanism. The middle gateway 11 monitors the packets passing through, records the given scheduling strategies to dispatch the packets and sends the packets after rewriting the headers of the packets. Channel 14 and channel 15 correspond to the customized client channel for the clients 12 and the customized server channel for the servers 13, respectively. In the scheduling system 1 of the present invention, the middle gateway 11 can be implemented by software or by hardware (e.g., a network processor). If the middle gateway 11 is implemented by software, it can be disposed in the servers 13. If the middle gateway 11 is implemented by a network processor, it can be disposed between the clients 12 and the servers 13.

Some terminology is defined below to help explain the content of the present invention.

TCT: stands for the TCP (Transmission Control Protocol) connection table that is maintained to track existing TCP connections. Each row in TCT contains four columns, the source IP, the source port, the destination IP and the destination port of one TCP connection. When the packets pass through the middle gateway 11 from the servers 13 via the channel 15, a TCT is used to record the content of a session table and to pick up the information of the headers of the packets as indices for successive connections.

Rank of a task: stands for the priority of the scheduling order of a task. The rank of a task is determined by a workflow of an application by the concept of critical paths. The task most seriously affecting the execution of the application is regarded as the highest-rank task, which is executed first to avoid delaying other tasks that exhibit dependency on the highest-rank task (i.e., the dependency issue). All the tasks in the workflow are divided by level. When the tasks in one level have been executed, the tasks in the next lower level are ready to execute in order to avoid the dependency issue.

EFT: stands for Estimated Finish Time, which is a formula to estimate the finish time of a task utilizing the remaining resources of the servers. To use this formula, the time that each task enters each server is required; the application needs profiling to pick up the estimated computation cost, communication cost and the dependencies between tasks, and the clock rate and the bandwidth of each server also need to be considered.

FIG. 2 is the flow chart of the scheduling method for remote object procedure call of the present invention. Receiving the tasks (i.e., invocations) (Step S10) comprises receiving and checking the packets of the invocations sent from the client 12 to the server 13. Also, Step S10 records the details of the connections established between the clients 12 and the servers 13, and records new connection requests in TCT. Thus, the status of connections of the scheduling system 1 can be monitored. Prescheduling (Step S20) performs a preliminary load balancing for the stateful invocations that may continuously affect the loads of the servers to prevent an imbalance of the loads of the servers. Step S20 also saves the packets from the clients 12 to a queue. Performing a dynamic scheduling (Step S30) and dispatching the task (Step S40) will be described below in detail.

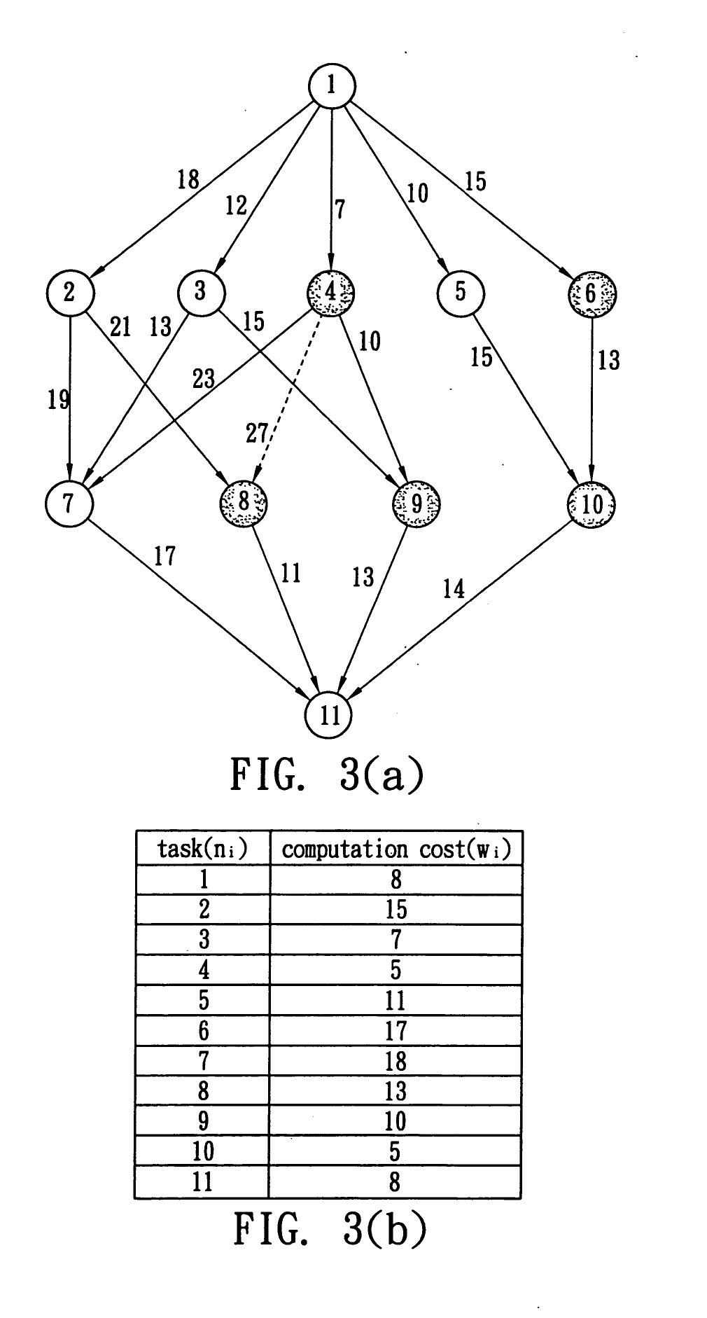

FIG. 3(a) illustrates a workflow of a simple application, in which each numbered node represents a task nᵢ that is also called an invocation. An arrowed line connecting two tasks means there is dependency between the two tasks and the task at the lower level is performed after the task at the higher level is completed. For example, the task n₃ is completed and then the task n₇ can be performed. The number beside the arrowed line means the communication cost thereof, which can be stored in an N×N matrix (not shown). A dashed arrowed line connecting the task n₄ and the task n₈ means the task n₈, which contacts the arrow, is estimated to be time-out. Note that the invocations in the workflow are divided into stateful (i.e., the tasks n₄, n₆, n₈, n₉ and n₁₀) and stateless. FIG. 3(b) shows an N×1 matrix used to store the computation cost for each task nᵢ.

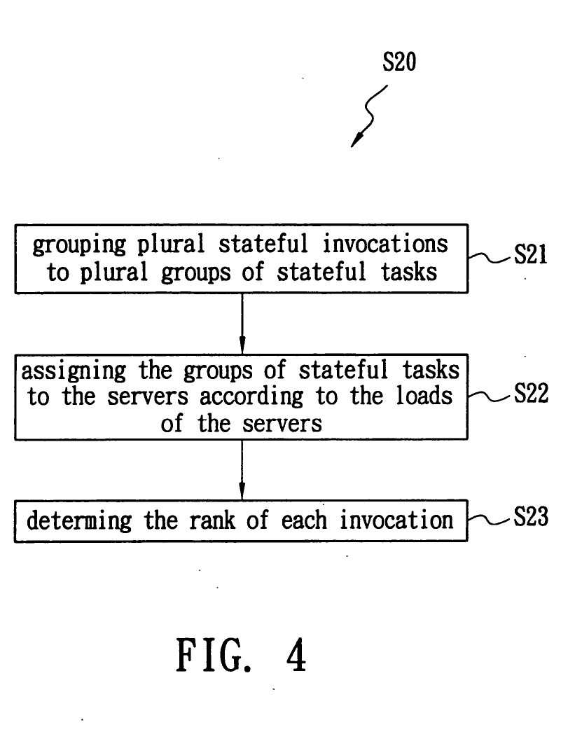

FIG. 4 shows the detailed steps of Step S20. First, the stateful invocations in a workflow are grouped into plural groups of stateful tasks (Step S21), in which the whole workflow is profiled and all the stateful invocations therein are recorded. The task, which is estimated to be time-out (e.g., the task n₈ in FIG. 3(a)), can be separated from an original group of stateful tasks to be regarded as a new group of stateful tasks. For example, in FIG. 3(a), if the tasks n₈, n₄ and n₉ are grouped to form a group of stateful tasks, and because the task n₈ is estimated to be time-out, the task n₈ can be separated to form a new group of stateful tasks. Note that the stateful invocations in each group of stateful tasks are dependent. After Step S21, the groups of stateful tasks are assigned to the servers according to the load of the servers (Step S22), which comprises the steps of: (B1) checking the load of the i-th server sᵢ, Load(sᵢ), by formula (1) that is the sum of the remaining computation time of each stateful invocation in the associated group of stateful tasks gⱼ (i.e., the stateful invocation belongs to the associated group of stateful tasks gⱼ) and the associated group of stateful tasks gⱼ has been scheduled for the i-th server sᵢ; (B2) calculating a total computation cost, AddLoad (sᵢ, gₜ), for the i-th server sᵢ, which is the sum of the load of the i-th server sᵢ, Load(sᵢ), and the load of a newly scheduled group. The load of the newly scheduled group is the remaining computation time of each stateful invocation in a newly scheduled group of stateful tasks gt; (B3) assigning one of the groups of stateful tasks to the server with the minimum total computation cost; and (B4) repeating Steps (B1) through (B3) until each of the groups of stateful tasks is assigned. The load of the i-th server sᵢ, Load(sᵢ), and the total computation cost for the i-th server sᵢ, AddLoad (sᵢ, gₜ), are defined by formulae (1) and (2) below, respectively.

$$\begin{matrix}Load ( {s}_{i} ) = {\sum }_{∀ {g}_{j} has been scheduled to Si} \{ {\sum }_{∀ {n}_{k} ∈ {g}_{j}} {R}_{k} \} & ( 1 ) \\ AddLoad ( {s}_{i} , {g}_{t} ) = Load ( {s}_{i} ) + \{ {\sum }_{∀ {n}_{k} ∈ {g}_{t}} {R}_{k} \} & ( 2 )\end{matrix}$$

where sᵢ is the i-th server, Rₖ is the remaining computation time of task nₖ, gⱼ is the j-th group of stateful tasks, and gₜ is the new group of stateful tasks.

After Step S22, the rank of each invocation is determined (Step S23). The rank rank(nᵢ) of a task nᵢ in the workflow is an approximation of the length of the longest path from the task nᵢ to the exit task (i.e., the task n₁₁ in FIG. 3(a)), which is defined by formula (3) below.

$$rank ( {n}_{i} ) = {w}_{i} + {max}_{{n}_{j} ∈ succ ( {n}_{i} )} ( {c}_{i , j} + rank ( {n}_{j} ) ) \qquad ( 3 )$$

where wᵢ is the computation cost of the task nᵢ, succ (nᵢ) is the set of the immediate successors of the task nᵢ, and cᵢⱼ is the communication cost associated with the tasks nᵢ and nⱼ. That is, the rank of each invocation can be determined by the computation cost of each invocation and the communication cost associated with one of the immediate successors of each invocation.

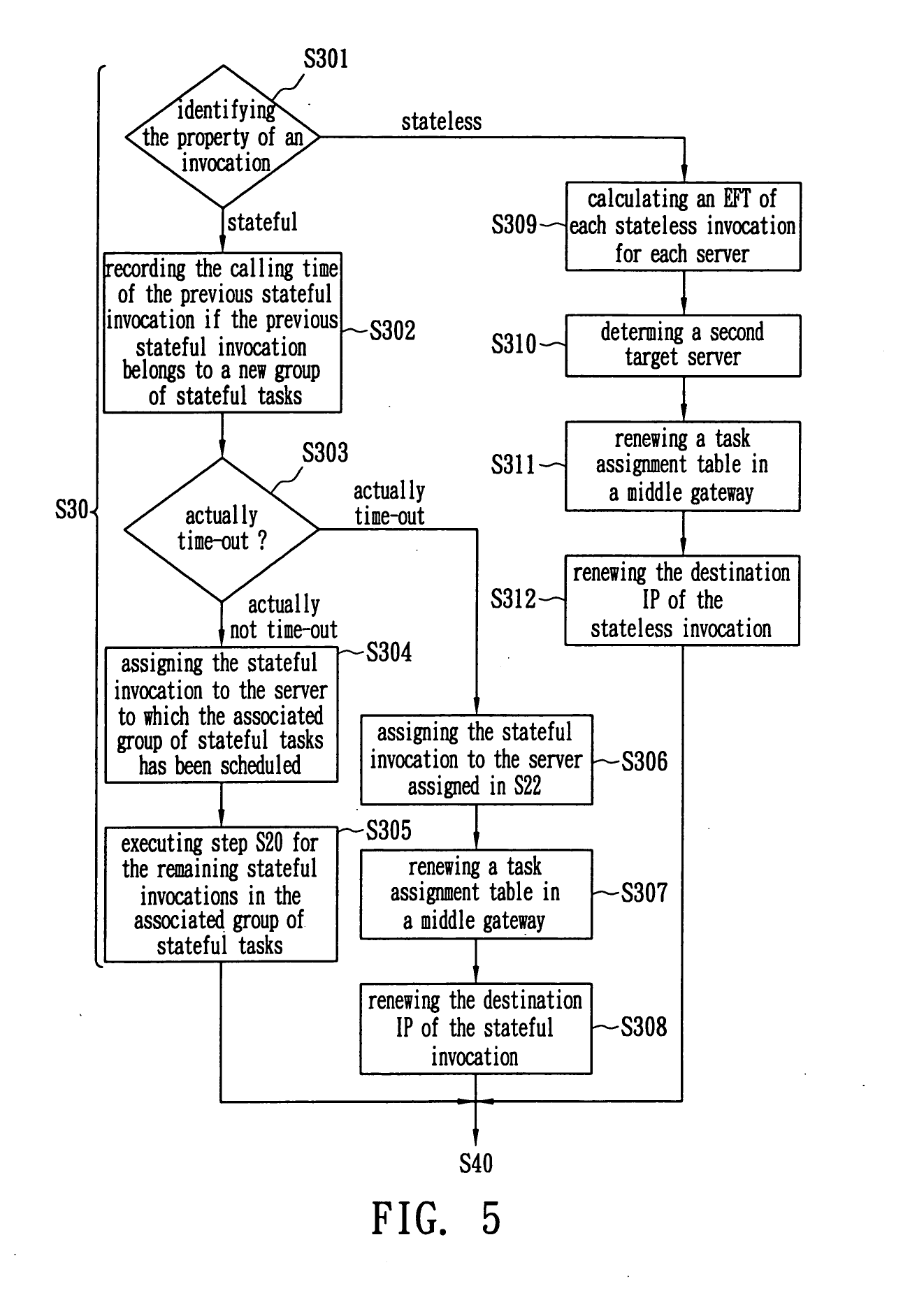

FIG. 5 is a flow chart of performing the dynamic scheduling (Step S30). First, the property of an invocation is identified to be stateful or stateless according to the destination port thereof (Step S301). If the invocation is stateful (a stateful invocation), the calling time of the previous stateful invocation is checked first. If the previous stateful invocation belongs to a new group of stateful tasks, the calling time thereof is recorded (Step S302). The new group of stateful tasks means its first task is estimated to be time-out. Then, the stateful invocation is checked if it is estimated to be time-out to see if it is actually time-out or not (Step S303). If the stateful invocation is estimated to be time-out but is actually not time-out, it will be assigned to the server to which the associated group of stateful tasks, which comprises the stateful invocation, has been scheduled (Step S304). After that, Step S20 is executed for the remaining stateful invocations in the associated group of stateful tasks (Step S305). If the stateful invocation is estimated to be time-out and is actually time-out, it will be assigned to the server assigned in Step S22 (Step S306). Then, a task assignment table is renewed (Step S307), wherein the task assignment table is disposed in a middle gateway that is connected to the server assigned in Step S22. Then, the destination IP of the stateful invocation is renewed (Step S308).

According to the result of Step S301, if the invocation is stateless, an EFT (Estimated Finish Time) of each stateless invocation for each server is calculated (Step S309). The EFT is determined by the estimated computation cost, the communication cost of each stateless invocation, the dependency thereof on the previous invocation, and the task assignment table that is associated. The EFT(nᵢ, sᵢ) of the i-th stateless invocation nᵢ in the j-th server sⱼ is defined by formula (4) below.

$$EFT ( {n}_{i} , {s}_{j} ) = Exec ( {w}_{i} , avail [ {s}_{j} ] , k ) + {max}_{{n}_{m} ∈ pred ( {n}_{i} )} ( AFT ( {n}_{m} ) + {c}_{m , i} ) \qquad ( 4 )$$

where pred(nᵢ) is the set of immediate predecessor tasks of the task nᵢ, and avail[sⱼ] is the earliest time at which the server sⱼ is ready for task execution. AFT(nₘ) is the actual finish time of the task nₘ and c_{m,i} is the communication cost between the stateless tasks nₘ and nᵢ. Exec (wᵢ, avail[sⱼ], k) is the execution cost of the task nᵢ with computation cost wᵢ executed on the server sⱼ which can parallel execute most k tasks from time avail[sⱼ]. After Step S309, a second target server, with the minimum EFT among each server, is determined (Step S310) and the stateless invocation is assigned to the second target server. Then, the task assignment table in the middle gateway that connects to the second target server is renewed (Step S311). Next, the destination IP of the stateless invocation is renewed (Step S312). The step of dispatching the tasks (Step S40) follows Steps S305, S308 or S312. At Step S40, the assigned invocations are dispatched to the corresponding server by modifying the destination IP of the invocation to the destination of dispatching so as to complete the scheduling.

Between Step S23 of FIG. 4 and Step S301 of FIG. 5, the scheduling method of the present invention further comprises the steps of: (1) storing the packets of the invocations in a queue; and (2) checking the order of the packets in the queue, in which the next step (i.e., Step S301) is executed until the order of the packets in the queue is achieved; otherwise, the remaining packets need to wait.

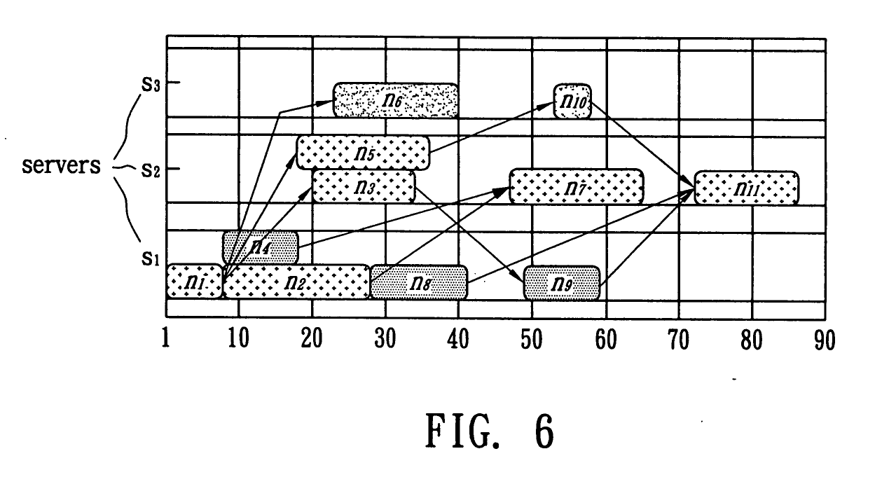

One embodiment of the scheduling method is given below. Referring to FIGS. 3(a) and 3(b), we take the workflow of FIG. 3(a) as an example, in which the tasks n₄, n₆, n₈, n₉ and n₁₀ are stateful, and there are three servers s₁, s₂ and s₃ in the current embodiment. Each server sᵢ can execute two tasks in parallel. First, the stateful tasks in the workflow are grouped into three groups of stateful tasks, g₁={n₄, n₉}, g₂={n₆, n₁₀} and g₃={n₈}. The stateful tasks n₄, n₈ and n₉ would have been grouped originally in the group of stateful tasks g₁. Since the task n₈ contacts the arrow of a dashed arrowed line (i.e., the task n₈ is estimated to be time-out), the task n₈ can be separated beforehand from the group of stateful tasks g₁ to form another group of stateful tasks g₃. Second, formulae (1) and (2) are applied to schedule the stateful tasks n₄, n₆, n₈, n₉ and n₁₀, in which the groups g₁, g₂ and g₃ are assigned to the servers s₁, S₂ and S₃, respectively (refer to FIG. 6). After the stateful tasks n₄, n₆, n₈, n₉ and n₁₀ are scheduled, the rank of each task is calculated, according to formula (3), as follows: n₁=93, n₂=77, n₃=62, n₄=71, n₅=53, n₆=57, n₇=43, n₈=32, n₉=31, n₁₀=27, and n₁₁=8. The ranks above can be rearranged by value as a scheduling sequence, n₁, n₂, n₄, n₃, n₆, n₅, n₇, n₈, n₉, n₁₀, n₁₁, to decide the scheduling order. The task n₁ with highest rank will be scheduled first. Then, because the task n₁ is stateless, the EFT value of the task n₁ for each server is calculated according to formula (4), and the minimum EFT is then determined. Since the task n₁ has no predecessor and is the first task for all servers s₁, S₂ and s₃, the value of (AFT(nₘ)+c_{m,i}) is 0 and the value of avail[sᵢ] is 0. Thus, the result of EFT is EFT(n₁, sᵢ)=Exec(8, avail[sᵢ], 2)+0=8. According to the scheduling sequence, the task n₂ is scheduled after the task n₁. The task n₂ is also stateless and the EFT value of the task n₂ for each server is calculated as follows. EFT(n₂, s₁)=Exce (15, avail[s₁],2)+max{AFT(n₁)+c_{1,2}}=15+(8+0)=23; EFT(n₂, s₂)=15+(8+18)=41; EFT(n₂, s₃)=15+(8+18)=41. From the above result, the task n₂ can be scheduled for the server s₁ with the minimum EFT value. Then, the task n₄ is scheduled according to the scheduling sequence. Since the task n₄ is stateful and is not estimated to be time-out in the workflow, it will be scheduled for the server s₁ that is determined by Step S22. Next, the EFT values of the task n₃ for each server are calculated as follows. EFT(n₃, s₁)=Exec(7×2, avail[s₁], 2)+max{AFT(n₁)+c_{1,2}}=14+(18+0)=32; EFT(n₃, s₂)=7+(8+12)=27; EFT(n₃, s₃)=7+(8+12)=27. Accordingly, the task n₃ will be scheduled for the server s₂. Each of the remaining tasks will be scheduled for a proper server according to the scheduling method of the present invention and the detail thereof is skipped. As for the task n₈, it is estimated to be time-out in the workflow but actually is not time-out when simulated. Therefore, the task n₈ is scheduled for the server s₁ to which the original group of stateful tasks (i.e., g₁) has been assigned.

FIG. 6 is the simulation result of the scheduling method of the present invention using the workflow of FIG. 3(a), which indicates the distribution of each task to each server. The x-coordinate represents the schedule length and the y-coordinate the three servers used in the simulation. The final schedule length is 86.

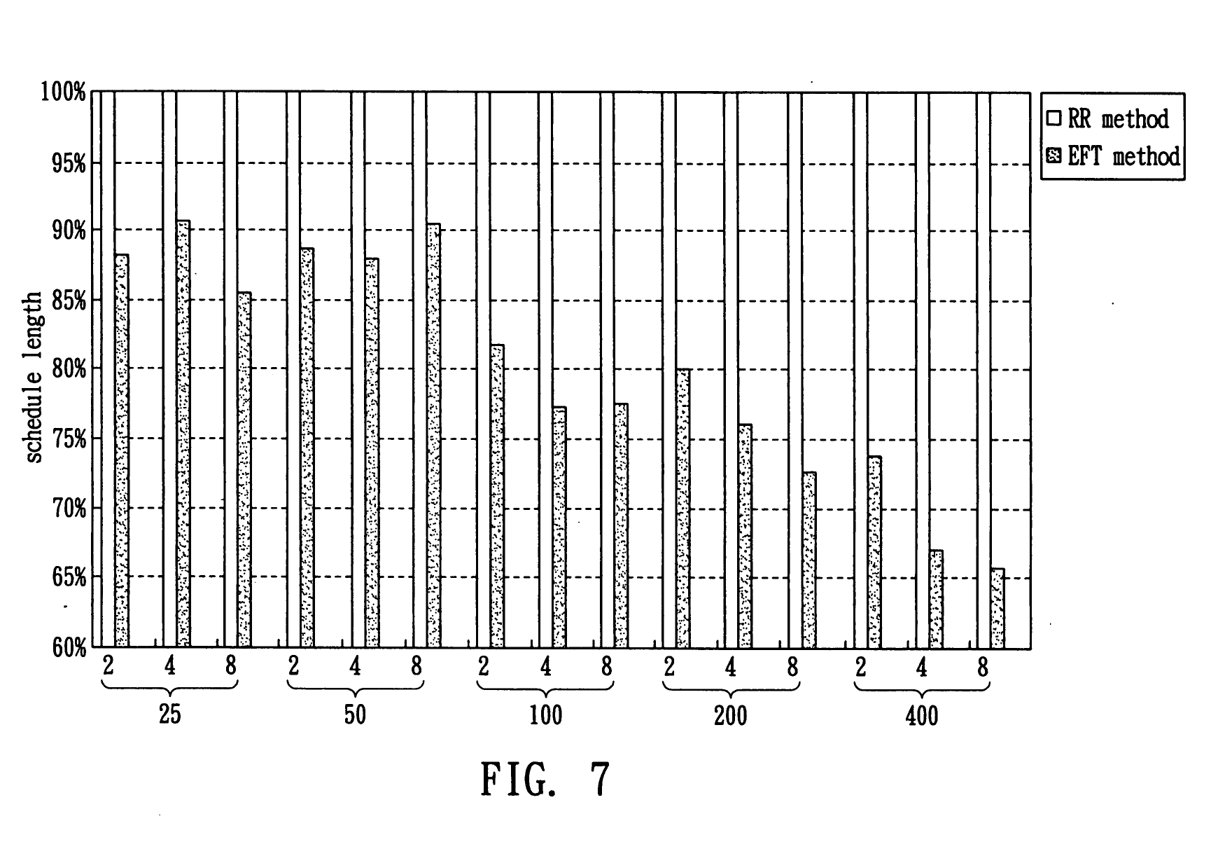

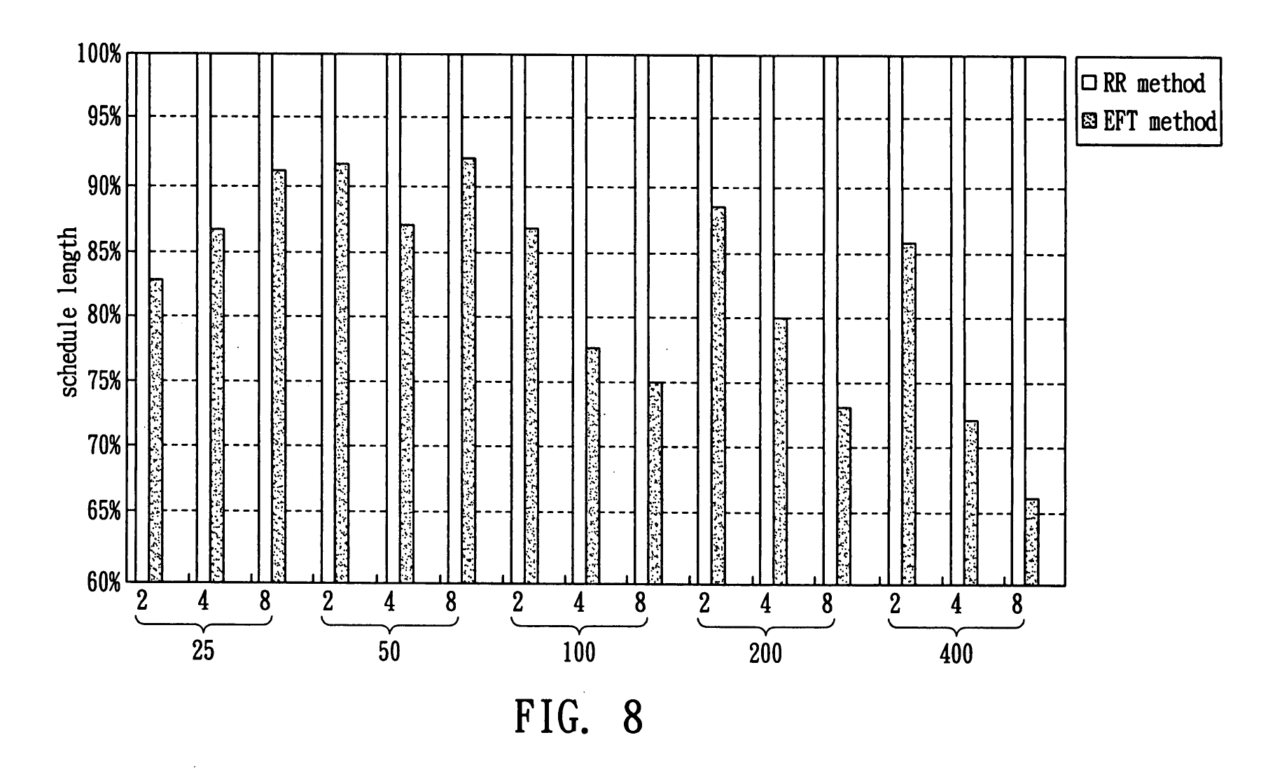

FIG. 7 and FIG. 8 show two graphs regarding the comparison between the performances of the scheduling method of the present invention (EFT method hereinafter) and a traditional round-robin method (RR method hereinafter). The workflow used in the two graphs is generated by a general graph generator and the parameters of the general graph generator are listed in Table

TABLE 1

| Parameter | Value |
|---|---|
| Number of tasks (v) | 25, 50, 100, 200, 400 |
| Shape of graph (s) | 1 |
| Out degree (o) | 2, 3, 4 |
| Communication to computation ratio (CCR) | 0.3 |
| Number of groups of stateful tasks | 2, 4, 8 |
| Stateful task ratio | 0.25, 0.5 |

The above parameters are explained as follows. Number of tasks (v) is the number of nodes (i.e., tasks) in the workflow. Shape of graph (s) is used to control the shape of graphs. The levels of generated graphs form a normal distribution with the mean value equal to \sqrt{ν}/s. The numbers of the nodes of each level also form a normal distribution with the mean value equal to \sqrt{ν}×s. Out degree (o) means out edges of each node, which is used to control the dependence degrees between two nodes. CCR is the ratio of the communication cost to the computation cost. We can generate computation-intensive application graphs by assigning low values to CCR. Stateful task ratio means the ratio of the number of stateful tasks to the number of all the tasks in the workflow. Under the parameter settings in Table 1, the performance results of two different stateful task ratios, 25% and 50%, are shown in FIG. 7 and FIG. 8, respectively, in which 500 graph instances are used for evaluating each parameter setting. The x-coordinate represents the distribution of different numbers of tasks (i.e., 25, 50, 100, 200 and 400) and three different numbers of groups of stateful tasks (i.e., 2, 4 and 8). The result with the EFT method is normalized to that of the RR method. From FIG. 7, the improvement of the EFT method is from 9.31% to 34% when compared with the RR method. From FIG. 8, the improvement of the EFT method is from 8% to 34% when compared with the RR method.

The above-described embodiments of the present invention are intended to be illustrative only. Numerous alternative embodiments may be devised by persons skilled in the art without departing from the scope of the following claims.

We claim:

1. A scheduling method for remote object procedure call, comprising the steps of:
(a) providing a plurality of servers and a workflow comprising a plurality of stateful invocations and a plurality of stateless invocations;
(b) grouping the stateful invocations into a plurality of groups of stateful tasks;
(c) assigning the groups of stateful tasks to the servers according to loads of the servers;
(d) determining rank of each invocation; and
(e) scheduling the stateful invocations and the stateless invocations according to the ranks thereof, comprising:
calculating an estimated finish time for each stateless invocation executed on the servers; and
assigning each stateless invocation to a corresponding server with the minimum estimated finish time.

2. The scheduling method for remote object procedure call of claim 1, being applied to a distributed component environment.

3. The scheduling method for remote object procedure call of claim 1, wherein the stateful invocations in each group of stateful tasks are dependent.

4. The scheduling method for remote object procedure call of claim 1, wherein Step (c) for assigning the groups comprises the steps of:
(c1) calculating a total computation cost for each server, the total computation cost comprising load of the corresponding server and load of the group of stateful tasks assigned to the corresponding server;
(c2) assigning one of the groups of stateful tasks to the server with minimum total computation cost; and
(c3) repeating Steps (c1) and (c2) until each of the groups of stateful tasks is assigned.

5. The scheduling method for remote object procedure call of claim 4, wherein the load of the corresponding server is a sum of a remaining computation time of each stateful invocation whose associated group of stateful tasks is assigned to the corresponding server.

6. The scheduling method for remote object procedure call of claim 1, wherein the rank of each invocation is determined by computation cost thereof and communication cost of a next invocation.

7. The scheduling method for remote object procedure call of claim 1, wherein the rank of each invocation is determined in accordance with of length of a longest path from each invocation to an exit invocation of workflow.

8. The scheduling method for remote object procedure call of claim 1, being applicable to a remote invocation method that utilizes Transmission Control Protocol Channel.

9. The scheduling method for remote object procedure call of claim 8, wherein the remote invocation method is .NET Remoting or Java RMI.

10. The scheduling method for remote object procedure call of claim 1, wherein Step (e) for scheduling the stateful invocations further comprises the step of:
assigning the stateful invocation to the server to which the associated group of stateful tasks has been assigned, if the stateful invocation is estimated to be time-out but is actually not time-out.

11. The scheduling method for remote object procedure call of claim 10, further comprising the steps of executing Steps (b), (c) and (d) for the remaining stateful invocations in the associated group of stateful tasks.

12. The scheduling method for remote object procedure call of claim 1, wherein Step (e) for scheduling the stateful invocations further comprises the step of:
recording calling time of a previous stateful invocation if the previous stateful invocation belongs to a new group of stateful tasks.

13. The scheduling method for remote object procedure call of claim 1, wherein Step (e) for scheduling the stateful invocations further comprises the step of:
scheduling the stateful invocation to the server assigned in Step (c) if the stateful invocation is actually time-out.

14. The scheduling method for remote object procedure call of claim 1, wherein Step (e) for scheduling the stateful invocations further comprises the step of:
identifying whether the invocation is stateful or stateless according to the destination port thereof.

15. The scheduling method for remote object procedure call of claim 1, wherein an estimated finish time is determined by the estimated computation cost, the communication cost of each stateless invocation, dependency thereof on the previous invocation, and a task assignment table that is associated.

16. The scheduling method for remote object procedure call of claim 1, wherein Step (e) for scheduling the stateful invocations further comprises the steps of:
renewing a task assignment table in a middle gateway connecting to the servers; and
renewing a destination IP of each invocation.

17. The scheduling method for remote object procedure call of claim 1, further comprising the steps between Step (d) and Step (e):
storing the packets of the invocations in a queue; and
checking the order of the packets in the queue.

18. A scheduling system for remote object procedure call, comprising:
a plurality of clients;
a plurality of servers responding to a plurality of invocations from the clients; and
a middle gateway connecting the servers and the clients to dispatch the invocations to the servers according to a load-balancing mechanism.

19. The scheduling system for remote object procedure call of claim 18, wherein the middle gateway is implemented by software.

20. The scheduling system for remote object procedure call of claim 18, wherein the middle gateway is a network processor.

21. The scheduling system for remote object procedure call of claim 18, wherein the middle gateway is disposed on the servers.

22. The scheduling system for remote object procedure call of claim 18, which complies with .NET Remoting.

23. The scheduling system for remote object procedure call of claim 18, which complies with Java RMI.

24. The scheduling system for remote object procedure call of claim 18, wherein the invocations are divided into stateful invocations and stateless invocations.

25. A method of using the load-balancing mechanism of the scheduling system for remote object procedure call of claim 24, said method comprising the steps of:
load-balancing the plurality of stateful invocations, comprising:
grouping the stateful invocations into a plurality of groups of stateful tasks; and
assigning the groups of stateful tasks to the servers according to the loads of the servers;
determining the rank of each invocation; and
scheduling the invocations according to the rank thereof, comprising:
calculating an estimated finish time for each stateless invocation executed on the servers; and
assigning each stateless invocation to the server with the minimum estimated finish time.

26. The method of claim 25, wherein the step of scheduling the invocations according to the rank thereof further comprises the steps of:
renewing a task assignment table in the middle gateway; and
renewing the destination IP of each invocation.
